(19) United States
(12) Patent Application Publication
(10) Pub. No.: US 2022/0292889 A1
(43) Pub. Date: Sep. 15, 2022

(54) INFORMATION PROCESSING APPARATUS AND STORAGE MEDIUM

(71) Applicant: HONDA MOTOR CO., LTD., Tokyo (JP)

(72) Inventors: Yoshimori Tanizawa, Tokyo (JP); Akira Fukunaga, Tokyo (JP); Sho Tsugane, Tokyo (JP)

(73) Assignee: HONDA MOTOR CO., LTD., Tokyo (JP)

(21) Appl. No.: 17/588,751

(22) Filed: Jan. 31, 2022

(30) Foreign Application Priority Data
Mar. 11, 2021 (JP) 2021-039455

(51) Int. Cl. G07C 5/08; G06F 3/14; G06T 11/00; G06F 3/0481; G07C 5/02

(52) U.S. Cl. CPC G07C 5/085; G06F 3/14; G06T 11/00; G06F 3/0481; G07C 5/0825; G07C 5/02; G06V 20/56

(57) ABSTRACT

An information processing apparatus includes an acquisition unit configured to acquire, from a vehicle, activation history information of driving assistance by a driving assistance system on the vehicle and motion history information of the vehicle, and a display control unit configured to cause a display device to display behavior information indicating chronological behavior of the vehicle in a situation in which the driving assistance was activated, based on the activation history information and the motion history information acquired by the acquisition unit.

### CROSS-REFERENCE TO RELATED APPLICATION(S)

This application claims priority to and the benefit of Japanese Patent Application No. 2021-039455 filed on Mar. 11, 2021, the entire disclosure of which is incorporated herein by reference.

### BACKGROUND OF THE INVENTION

### Field of the Invention

The present invention relates to an information processing technology.

### Description of the Related Art

A technique is known in which information while a vehicle is traveling is stored in the vehicle, and the stored information is used for inspection and maintenance (for example, Japanese Patent Laid-Open No. 3-28045).

With advancements in a driving assistance system for a vehicle, various supports such as automatic braking, automatic steering, and a notification for attention attracting are given to a driver, and contribute to improvements in safety of the vehicle. On the other hand, when the driving assistance is activated, drivers may not be able to immediately recognize the cause of the activation. Hence, the drivers feel strange about the activation of the driving assistance, in some cases. The drivers who feel strange may consider that a failure might have occurred in the vehicle and ask for an explanation at an automobile dealer.

A person in charge at the dealer determines the state of the driving assistance system based on the information that has been accumulated in the vehicle, and gives an explanation to the driver that there is no abnormality as long as the driving assistance system is normal. However, the explanation includes technical contents, and it may be difficult for the drivers to understand the explanation only with oral explanation or written explanation indicating the technical matters.

### SUMMARY OF THE INVENTION

An object of the present invention is to provide a tool capable of explaining an activation situation of a driving assistance system in a more easily understandable manner.

According to an aspect of the present invention, there is provided an information processing apparatus comprising: an acquisition unit configured to acquire, from a vehicle, activation history information of driving assistance by a driving assistance system on the vehicle and motion history information of the vehicle; and a display control unit configured to cause a display device to display behavior information indicating chronological behavior of the vehicle in a situation in which the driving assistance was activated, based on the activation history information and the motion history information acquired by the acquisition unit.

Further features of the present invention will become apparent from the following description of exemplary embodiments (with reference to the attached drawings).

### BRIEF DESCRIPTION OF THE DRAWINGS

FIG. 1 is a block diagram illustrating an information processing apparatus according to an embodiment of the present invention and an example of a vehicle that is an information acquisition target;

FIGS. 2A to 2C are each an explanatory diagram illustrating an example of driving assistance;

FIG. 3 is a flowchart illustrating a process example of the information processing apparatus of FIG. 1;

FIG. 4 is a diagram illustrating a display example of behavior information;

FIG. 5 is a diagram illustrating a display example of the behavior information;

FIG. 6 is a diagram illustrating a display example of the behavior information;

FIG. 7 is a diagram illustrating a display example of the behavior information;

FIG. 8 is a diagram illustrating a display example of the behavior information;

FIG. 9 is a diagram illustrating a display example of the behavior information;

FIG. 10 is a diagram illustrating a display example of the behavior information;

FIG. 11 is a diagram illustrating a display example of the behavior information;

FIG. 12 is a diagram illustrating a display example of the behavior information;

FIG. 13 is a diagram illustrating a display example of the behavior information;

FIG. 14 is a diagram illustrating a display example of the behavior information;

FIG. 15 is a diagram illustrating a display example of the behavior information; and

FIG. 16 is a diagram illustrating a display example of the behavior information.

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar configurations, and redundant description thereof is omitted.

### First Embodiment

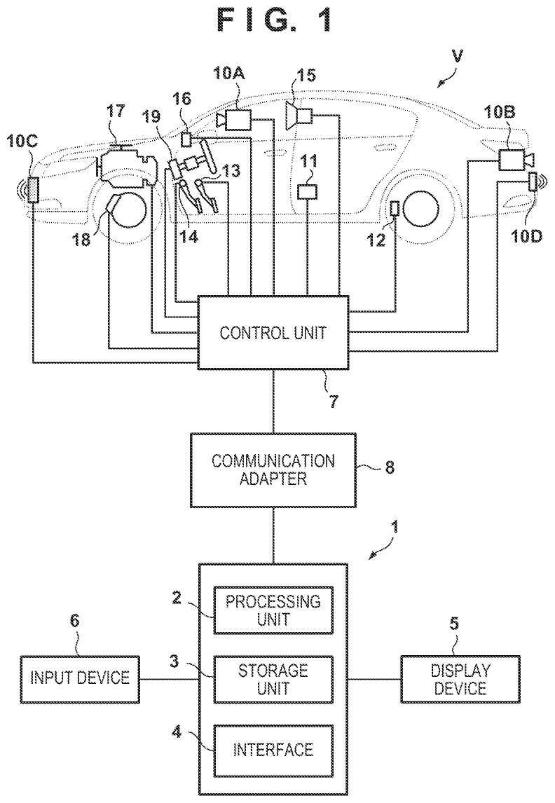

FIG. 1 is a block diagram illustrating an information processing apparatus 1 according to an embodiment of the present invention and an example of a vehicle V that is an information acquisition target. The vehicle V is, for example, a four-wheeled passenger vehicle of a sedan type. The vehicle V includes a control unit 7. The control unit 7 includes a processor represented by a CPU, a storage device such as a semiconductor memory, an interface with an external device, and the like. In the storage device, programs executed by the processor, data used for processing by the processor, and the like are stored. The control unit 7 may include a plurality of processors, storage devices, interfaces, and the like.

The control unit 7 is capable of recognizing a travel environment of the vehicle V, based on detection results of detection units 10A to 10D that respectively detect surrounding situations of vehicle V. In the present embodiment, the detection unit 10A is a camera that captures an image ahead the vehicle V, and the detection unit 10B is a camera that captures an image behind the vehicle V. By analyzing the images that have been captured by the detection units 10A and 10B, it is possible to extract a contour of a target or a lane division line (a white line or the like) on a road. The detection unit 10C is a millimeter wave radar, detects a target ahead the vehicle V, and measures a distance to the target. The detection unit 10D is an ultrasonic sensor, detects a target behind the vehicle V, and measures a distance to the target. As the detection units 10A to 10D, sensors other than the camera, the millimeter wave radar, and the ultrasonic sensor can also be used, and their arrangements and detection ranges can also be appropriately designed.

The control unit 7 is also capable of acquiring detection results of an inertial sensor 11, a wheel speed sensor 12, an accelerator pedal sensor 13, and a brake pedal sensor 14. The inertial sensor 11 includes, for example, an acceleration sensor, a yaw rate sensor, and the like, and is capable of calculating, for example, the posture of the vehicle V using the detection results and, for example, the vehicle speed of the vehicle V using the wheel speed sensor 12. An accelerator operation amount and a brake operation amount of a driver can be calculated respectively from detection results of the accelerator pedal sensor 13 and the brake pedal sensor 14.

The control unit 7 is capable of controlling a drive source 17, a brake device 18, and an electric power steering 19. The drive source 17 includes, for example, an internal combustion engine and an automatic transmission, and the control unit 7 is capable of controlling the drive source 17 to control acceleration or deceleration of the vehicle V. The brake device 18 is, for example, a disc brake device, and the control unit 7 is capable of controlling the brake of the vehicle V using the brake device 18.

The electric power steering 19 is a mechanism that steers front wheels in accordance with a driving operation by the driver (steering operation) on a steering wheel. The electric power steering 19 includes a motor that exerts driving force (referred to as steering assist torque, in some cases) for assisting the steering operation, a steering angle sensor, a torque sensor that detects steering torque loaded by the driver, and the like. The control unit 7 is capable of controlling the steering of the vehicle V using the electric power steering 19, and is capable of calculating a steering amount of the driver.

The control unit 7 is also capable of controlling a sound output device 15 and a meter panel 16. The sound output device 15 is capable of notifying the driver of an alarm sound and the like. Various types of information can be displayed on the meter panel 16.

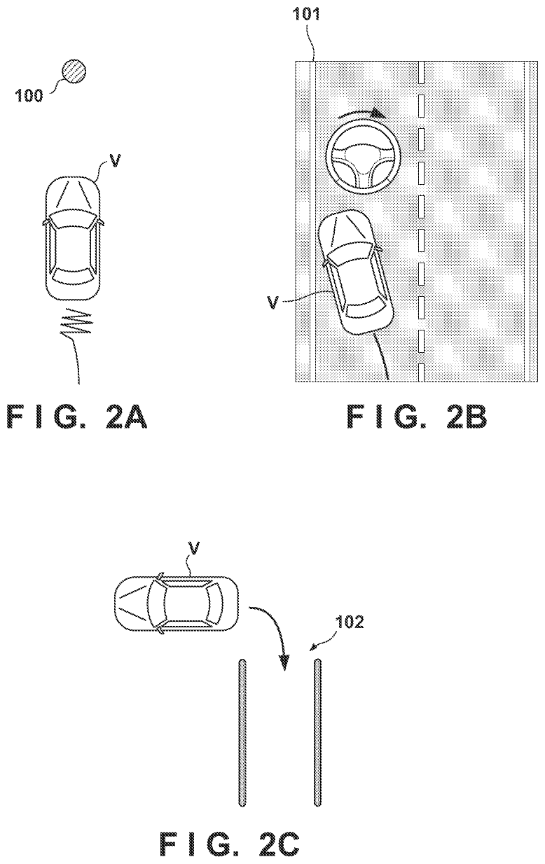

The control unit 7 constitutes a driving assistance system. As driving assistance, the control unit 7 is capable of conducting, for example, collision reduction brake, lane deviation suppression, parking assistance, and the like. FIG. 2A is an explanatory diagram of the collision reduction brake. The collision reduction brake denotes automatic braking. When an obstacle 100 is detected ahead the vehicle V by the detection unit 10A or 10C and the control unit 7 predicts a collision between the obstacle 100 and the vehicle V, the control unit 7 causes the sound output device 15 to give notification, or activates the brake device 18 to decelerate the vehicle V.

FIG. 2B is an explanatory diagram of the lane deviation suppression. The lane deviation suppression denotes automatic steering. When the possibility that the vehicle V deviates from the traveling lane increases, the control unit 7 causes the sound output device 15 to give notification, or controls the electric power steering 19 to steer the vehicle V so that the vehicle V keeps traveling inside the traveling lane. FIG. 2C is an explanatory diagram of the parking assistance. The control unit 7 recognizes a parking frame 102 from the detection results of the detection units 10A and 10B, and controls the drive source 17 and the electric power steering 19 to move the vehicle V into the parking frame 102.

The control unit 7 stores, in an internal storage device (drive recorder), activation history information of such driving assistance, and motion history information and operation history information of the vehicle V within a certain period of time before and after activation of the driving assistance. The activation history information includes all of driving assistance in the past that has been activated without an instruction of the driver, such as the collision reduction brake and the lane deviation suppression, and also includes driving assistance in the past that has been started by an instruction of the driver but has not been completed, such as a case where the parking assistance has been cancelled on a partway. The activation history information is stored in association with, for example, a total travel distance of the vehicle V, and includes information related to the driving assistance (activation trigger, activation timing, control amount, and the like). The motion history information is information related to a motion of the vehicle V, and includes control amounts of a vehicle speed, acceleration, deceleration, an angular velocity, a steering angle, the drive source 17, and the like. The operation history information denotes information related to the driving operation by the driver (accelerator operation amount, brake operation amount, steering angle, and the like).

Returning to FIG. 1, the information processing apparatus 1 is communicably connected with the control unit 7 through a communication adapter 8, and is capable of reading and acquiring the activation history information, the motion history information, and the operation history information that are stored in the control unit 7. The information processing apparatus 1 includes a processing unit 2, a storage unit 3, and an interface 4 between an external device and the processing unit 2. The processing unit 2 is a processor represented by a CPU, and executes a program stored in the storage unit 3. The storage unit 3 is a storage device such as a RAM, a ROM, or a hard disk. The storage unit 3 stores various types of data, in addition to the program executed by the processing unit 2. The various types of data include data used for displaying behavior information, as will be described later. The program executed by the processing unit 2 can also be installed in the information processing apparatus 1 with use of a storage medium such as a CD-ROM.

A display device 5 and an input device 6 are connected with the information processing apparatus 1. The display device 5 is, for example, a liquid crystal display device, and the information processing apparatus 1 causes the display device 5 to display the behavior information, as will be described later. The input device 6 is a mouse, a keyboard, or the like, and the information processing apparatus 1 is capable of receiving an operator's instruction that has been input into the input device 6. The information processing apparatus 1, the display device 5, and the input device 6 may be a desktop personal computer, a laptop personal computer, or a tablet provided with a touch panel.

### Process Example

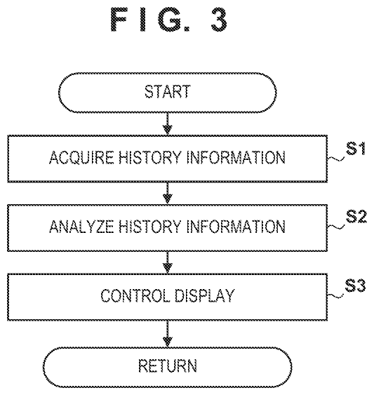

A process example of the information processing apparatus 1 will be described. At the time of inspection, maintenance, or the like of the vehicle V, the information processing apparatus 1 is connected to the control unit 7 of the vehicle V through the communication adapter 8. FIG. 3 is a flowchart illustrating a process example performed by the processing unit 2 in such a situation. In S1, the information processing apparatus 1 acquires, from the control unit 7, history information (the activation history information, the motion history information, and the operation history information that have been described above) stored in the control unit 7 through communication between the information processing apparatus 1 and the control unit 7.

In S2, the history information that has been acquired is analyzed to generate information to be displayed on the display device 5. In S3, display control of displaying the information generated in S2 on the display device 5 is conducted. The display in S3 includes a display for service staff of an automobile dealer to check the state of the vehicle V, and in addition, a display for explaining the driving assistance time of the vehicle V in response to a request from the owner of the vehicle V. When the owner of the vehicle V feels strange about the activation of the driving assistance in the past, the owner requests its explanation in some cases. The service staff gives the explanation to the owner using the display of the display device 5.

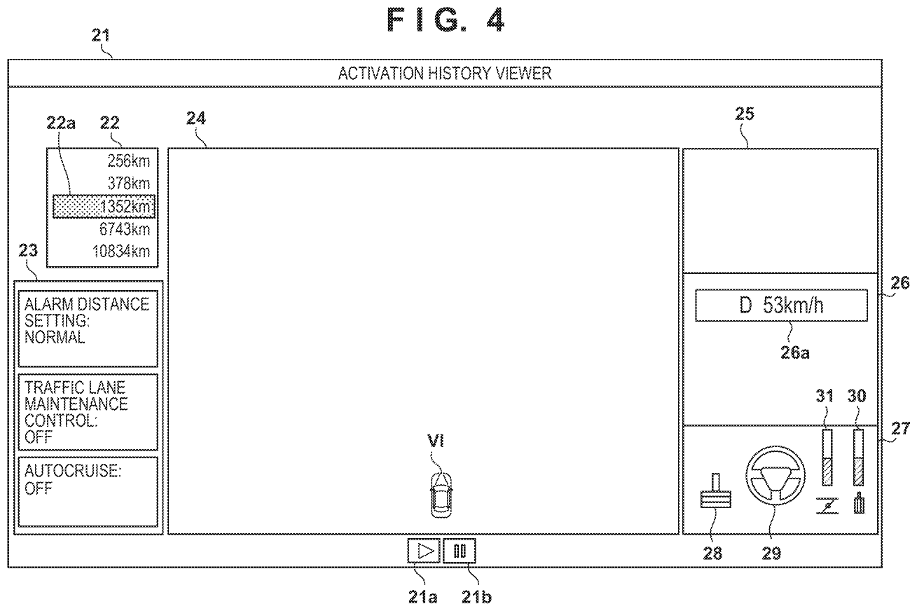

FIG. 4 illustrates a display example of the display device 5, and illustrates an example of behavior information 21 showing chronological behavior of the vehicle V in a situation where the driving assistance was activated.

The behavior information 21 includes a total travel distance display area 22. As described above, in the present embodiment, the activation history information is associated with the total travel distance of the vehicle V. The total travel distance display area 22 displays a list of travel distances while the driving assistance was being activated, so that information of the driving assistance in the past to be desired to reproduce can be selected from the list.

For example, the service staff makes a conversation with the owner, and obtains an approximate travel distance at the time of activation of the driving assistance for which the owner requests an explanation, and selects, from the total travel distance display area 22, one of the traveled distances that is similar to the traveled distance that has been obtained from the owner. In the illustrated example, the history when traveled for 1352 km is selected by a cursor 22a. When the traveled distance is selected, the corresponding history information is determined.

The behavior information 21 includes a setting display area 23. In the setting display area 23, various settings of the vehicle V at the time of activation of the driving assistance are indicated. The illustrated example shows that “alarm distance setting” was normal, “lane keeping control” was OFF (not activated) and “autocruise” was OFF. The “alarm distance setting” denotes a setting of a predetermined distance to be notified to the driver, when an obstacle and the vehicle V becomes in proximity to each other to a predetermined distance. The “lane keeping control” is the same as the lane deviation suppression described above, and when this is OFF, the driving assistance related to the lane deviation suppression is not activated. The “autocruise” denotes automatic following control with respect to a preceding vehicle, and does not activate when this is OFF.

The behavior information 21 includes a reproduced video display area 24 in which a video reproducing the behavior of the vehicle V is displayed. In the present embodiment, the chronological behavior of the vehicle V is displayed in a video, as the behavior information. In the illustrated example, a vehicle image VI corresponding to the vehicle V is displayed in a plan view, and the video showing the behavior of the vehicle V in a bird's-eye view is displayed. The vehicle image VI may be a photographic image of the actual vehicle. The display at the stage of FIG. 4 is an initial display before the reproduction starts. When a selection operation of a reproduction button 21a is performed, the reproduction of a video is started. When a selection operation of a stop button 21b is performed, the reproduction of the video is stopped.

The behavior information 21 includes an assistance content display area 25. In the assistance content display area 25, information indicating the type of the driving assistance that has been activated is displayed. This information is displayed at a timing corresponding to an actual activation timing in synchronization with the reproduced video displayed in the reproduced video display area 24. In the illustrated example, the video is not displayed yet.

The behavior information 21 includes a meter reproduction area 26. In the meter reproduction area 26, an image for reproducing the display content of the meter panel 16 while the driving assistance was being activated is displayed. In the illustrated example, the shift range of the automatic transmission of the drive source 17 is D range, and the vehicle speed is 53 km/h.

The behavior information 21 includes an operation display area 27. In the operation display area 27, information indicating a driving operation or the like performed by the driver while the driving assistance was being activated is displayed. In the illustrated example, an accelerator operation amount is indicated by a level meter 30. In addition, the level meter 30 indicates a throttle opening degree of the internal combustion engine (control information of the internal combustion engine). Regarding steering information 29, a steering amount operated by the driver or a steering amount of automatic steering activated by the driving assistance is displayed with use of an icon indicating a steering wheel. Regarding brake information 28, the brake operation performed by the driver or the presence or absence of the automatic braking activated by the driving assistance is displayed with use of an icon indicating a brake pedal.

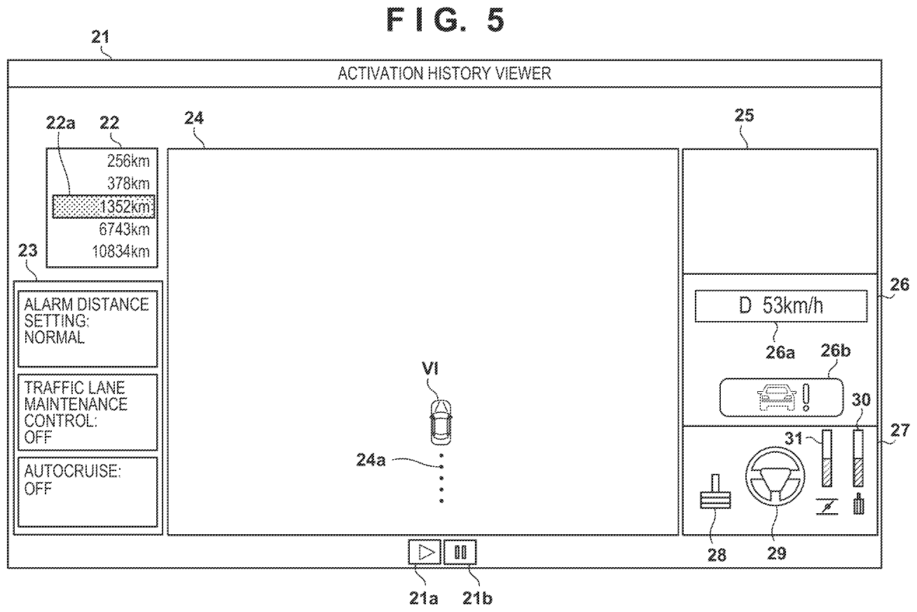

Changes in the display of the behavior information 21 after the reproduction button 21a is operated will be described with reference to FIGS. 5 to 8. The display of the behavior of the vehicle image VI is controlled based on the motion history information. FIG. 5 illustrates a stage before the driving assistance was activated. The vehicle image VI is traveling forward. A traveled track 24a indicates a track on which the vehicle image VI (that is, the vehicle V) has moved. At this stage, an icon 26b for calling attention to a preceding vehicle is displayed in the meter reproduction area 26. That is, it can be understood that while the vehicle V was actually traveling, at this timing, the detection unit 10A or 10C detected proximity to the preceding vehicle.

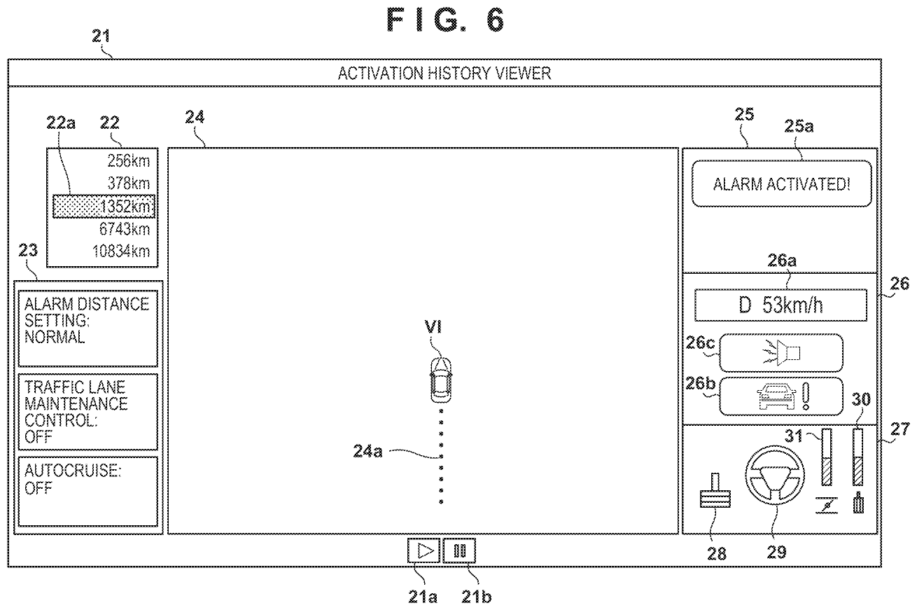

FIG. 6 illustrates a stage where time elapsed from the state of FIG. 5. The vehicle image VI travels forward, but no brake operation is performed, and no change is found in the display of the level meter 30 (the accelerator operation amount). At this stage, in the assistance content display area 25, information 25a indicating that an alarm for calling attention to the preceding vehicle was activated. In addition, in the meter reproduction area 26, an icon 26c indicating that a notification was given is displayed, in addition to the icon 26b for calling attention to the preceding vehicle. That is, it can be understood that while the vehicle V was actually traveling, at this timing, the driving assistance for calling attention to the proximity to the preceding vehicle was conducted.

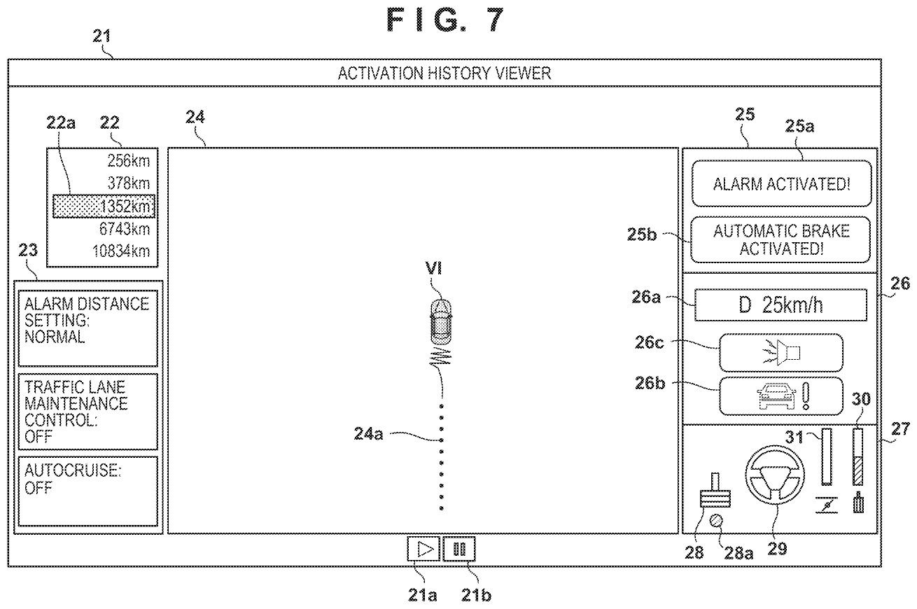

FIG. 7 illustrates a stage where time elapsed from the state of FIG. 6. The brake is being activated while the vehicle image VI is traveling forward. At this stage, in the assistance content display area 25, information 25b indicating that the automatic braking (the collision reduction brake) was activated is displayed, in addition to the information 25a indicating that an alarm for calling attention to the preceding vehicle was activated. In addition, the vehicle speed that is decreasing is displayed in the vehicle speed display in the meter reproduction area 26. No change is found in the display (the accelerator operation amount) of the level meter 30 (the driver is continuously performing the accelerator operation), but the throttle opening degree is decreasing in the display of the level meter 30 indicating the throttle opening degree (the output of the internal combustion engine is controlled to be reduced). In the operation display area 27, information 28a indicating that the automatic braking was activated is displayed to be adjacent to the brake information 28. That is, it can be understood that while the vehicle V was actually traveling, the driving assistance was conducted by the activation of the automatic braking.

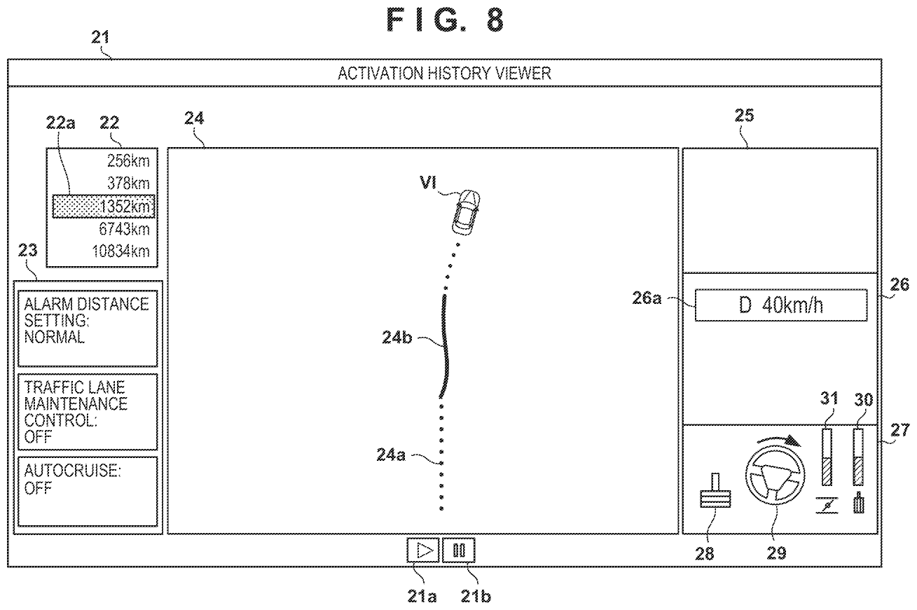

FIG. 8 illustrates a stage after time elapsed from the state of FIG. 7 and the driving assistance ended. The vehicle image VI travels forward, and turns slightly to the right. The display related to the driving assistance has disappeared from the assistance content display area 25, the meter reproduction area 26, and the operation display area 27. In the operation display area 27, the steering information 29 indicates that the driver is performing a steering operation to the right. An activation section 24b of the automatic braking is displayed on the traveled track 24a. From the display of FIG. 8, it is supposed that while the vehicle V was actually traveling, the vehicle V was continuously traveling without colliding with the preceding vehicle after the activation of the automatic braking.

By presenting the behavior information 21 as described above to the owner of the vehicle V who has requested the explanation, it becomes possible to explain the activation situation of the driving assistance system in a more easily understandable manner, and it becomes possible to clear up misunderstanding of malfunction and failure. In particular, by displaying the video reproducing the behavior of the vehicle V in the reproduced video display area 24, it is possible to explain in a visually recognizable manner. In addition to the reproduced video, information regarding the working situation of the vehicle V and the operating situation by the driver at the time of activation of the driving assistance is also displayed. Therefore, it becomes possible for the owner of the vehicle V to understand the relationship and the like between the activation situation of the driving assistance system and the driving operation performed by the driver in a more easily understandable manner.

### Second Embodiment

In the first embodiment, the behavior of the vehicle V has been displayed in a video. However, in the present embodiment, furthermore, a description will be given with regard to a tool capable of displaying reference information about a travel environment of a road on which the vehicle V is traveling at the time of activation of the driving assistance. It becomes easy for the owner of the vehicle V who listens to the explanation to intuitively recognize the situation that triggered the activation of the driving assistance.

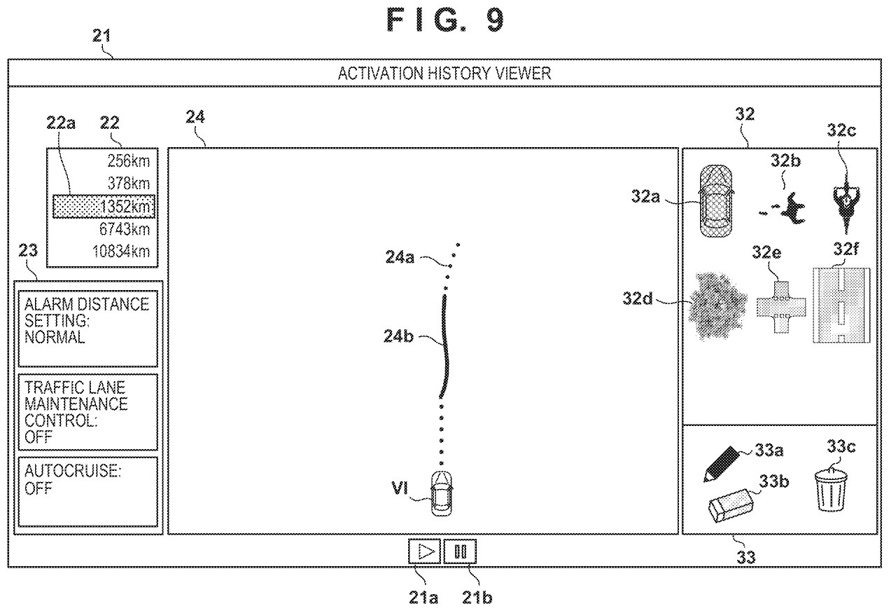

FIG. 9 is a display example of the display device 5 illustrating one such example. In the present embodiment, as an optional function in the behavior information 21, which has been described with reference to FIGS. 4 to 8, an editing function capable of displaying various items in the reproduced video display area 24 is included.

In an item area 32, items that can be displayed in the reproduced video display area 24 are listed. An item 32a is an icon representing an automobile, an item 32b is an icon representing a pedestrian, and an item 32c is an icon representing a bicycle and a rider. An item 32d is an icon representing a street tree, an item 32e is an icon representing an intersection, and an item 32f is an icon representing a road. An operator performs a selection operation of selecting an item from the item area 32 using the input device 6, and performs a drag operation or the like of dragging the selected item into the reproduced video display area 24. Accordingly, the selection is received and the selected item is displayed in the reproduced video display area 24.

In an editing area 33, a free drawing tool 33a, an eraser tool 33b, and a trash box tool 33c are displayed. The operator selects the free drawing tool 33a using the input device 6, and is able to freely draw a line and a figure in the reproduced video display area 24. The eraser tool 33b is a tool for deleting the free line and the figure that have been drawn in the reproduced video display area 24, and the trash box tool 33c is a tool for deleting the icon that has been selected from the item area 32 and displayed in the reproduced video display area 24.

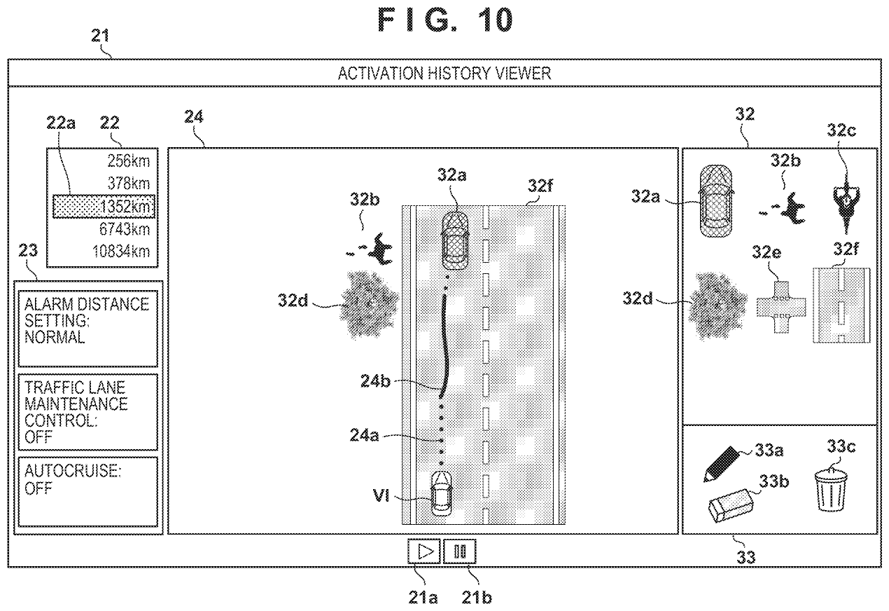

The service staff interviews the owner about the travel environment of the road on which the vehicle V was traveling at the time of activation of the driving assistance, and performs an editing operation on the reproduced video display area 24 by using the item in the item area 32 and each tool of the editing area 33. FIG. 10 illustrates a display example after editing, and a still image of the travel environment is displayed in a superimposed manner in the reproduced video display area 24. The operation of the reproduction button 21a enables reproduction of the reproduced video of the vehicle image VI illustrated in FIGS. 5 to 8 (the still image of the travel environment remains without change). The service staff and the owner continuously have a conversation with reference to such displays, so that the owner can understand an activation trigger and the like of the driving assistance and clear up misunderstanding of malfunction and failure.

### Third Embodiment

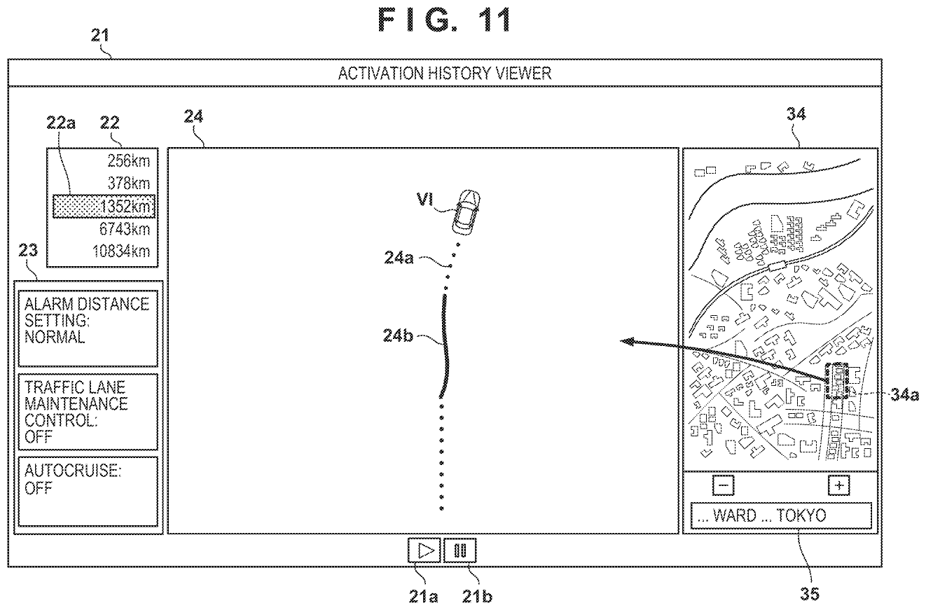

In the second embodiment, a still image that has been created by the operator is displayed in a superimposed manner as reference information about the travel environment on the road. However, the map information may be displayed in a superimposed manner. FIG. 11 is a display example of the display device 5 illustrating one such example. Also in the present embodiment, as an optional function in the behavior information 21, which has been described with reference to FIGS. 4 to 8, an editing function capable of displaying the map information in the reproduced video display area 24 is included.

In a map display area 34, an image of an aerial photograph is displayed as the map information. The image of the aerial photograph may be stored beforehand in the storage unit 3, or may be acquired by the information processing apparatus 1 from a providing server for providing the map information through a network such as the Internet. The operator performs a selection operation of selecting a display range from the map display area 34 using a frame 34a on the input device 6, and performs a drag operation or the like of dragging the display range into the reproduced video display area 24. Accordingly, the selection is received and the image of the frame 34a is displayed in the reproduced video display area 24. By inputting regional information into an input box 35, the region of the map displayed in the map display area 34 can be changed.

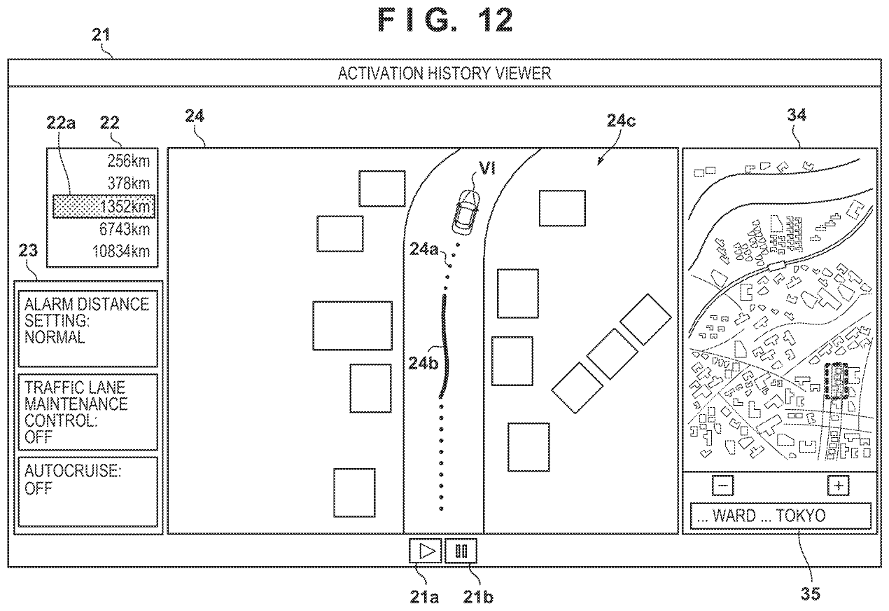

The service staff interviews the owner about the location of the road on which the vehicle V was traveling at the time of activation of the driving assistance, inputs information of the location into the input box 35, and selects map information from the map display area 34 to display the map information in the reproduced video display area 24. FIG. 12 illustrates a display example after the selection of the map information, and an image 24c of the aerial photograph is displayed in the reproduced video display area 24 in a superimposed manner. The operation of the reproduction button 21a enables reproduction of the reproduced video of the vehicle image VI illustrated in FIGS. 5 to 8 (the image 24c of the aerial photograph remains without change). The service staff and the owner continuously have a conversation with reference to such displays, so that the owner can understand an activation trigger and the like of the driving assistance and clear up misunderstanding of malfunction and failure.

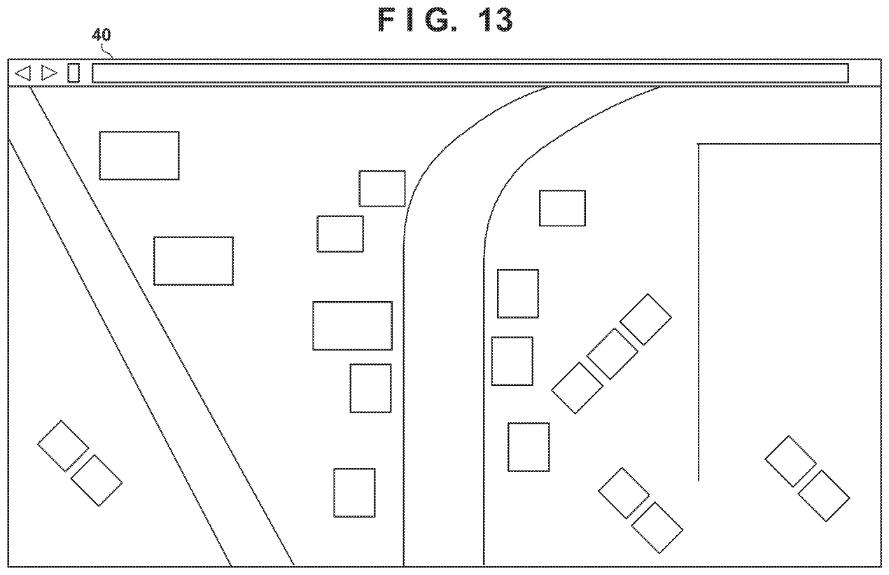

As another method for displaying the map information on the reproduced video display area 24 in a superimposed manner, method of setting transmission of the background of the reproduced video display area 24 selectable and displaying the map information as the background is also adoptable. FIGS. 13 to 15 each illustrate one such example.

FIG. 13 illustrates a display example of the map information serving as a background. In the illustrated example, a window 40 such as an Internet browser is illustrated. In the window 40, the map information (such as an aerial photograph) provided on the Internet is displayed. The operator is able to freely change the location to be displayed in the window 40 and perform an operation for enlargement or reduction.

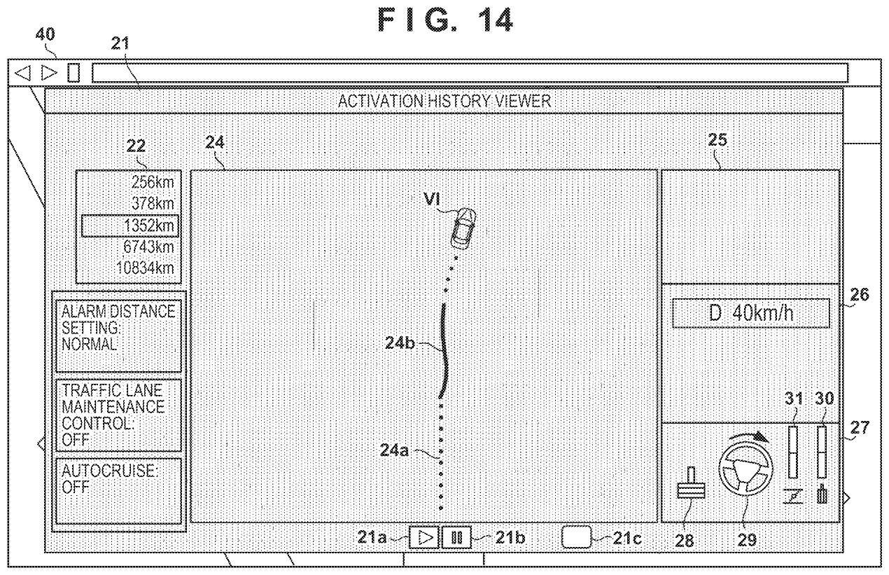

A window of the behavior information 21 is superimposed on the window 40. FIG. 14 illustrates one such example. At the stage of FIG. 14, the reproduced video display area 24 is displayed in a non-transmissive state. Therefore, the map information of the window 40 on a rear side is not displayed. Note that, in the illustrated example, shading is applied to the behavior information 21 in order to visually understand the overlapping relationship between the two.

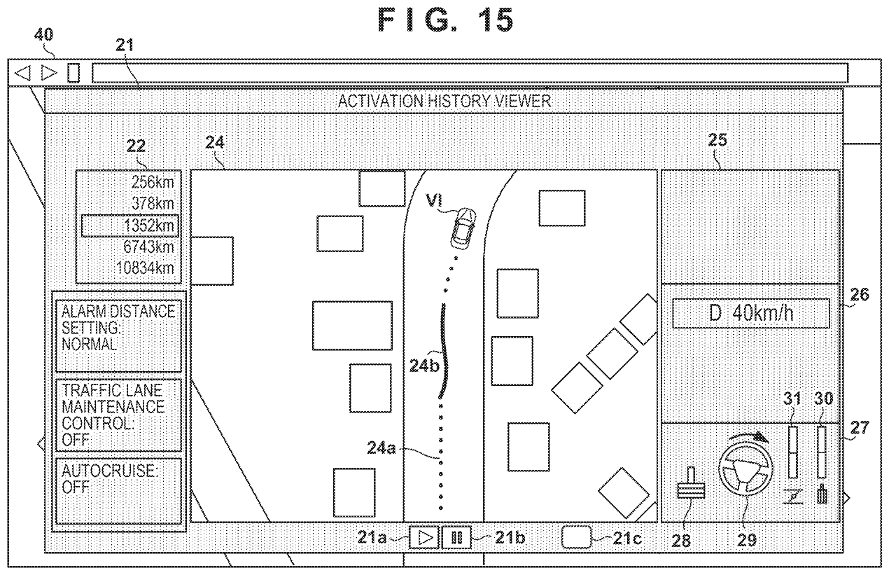

The behavior information 21 is provided with a transmission selection button 21c. When the operator operates the transmission selection button 21c, the reproduced video display area 24 becomes a transmissive state as illustrated in FIG. 15, and the map information of the window 40 on the rear side is displayed. In this state, in the frame of the reproduced video display area 24, the operator is also able to freely change the location to be displayed in the window 40 and perform an operation for enlargement or reduction. Further, the operation of the reproduction button 21a enables reproduction of the reproduction video of the vehicle image VI illustrated in FIGS. 5 to 8 (the display of the map information remains without change).

By enabling the selection between a transmissive state and a non-transmissive state of the reproduced video display area 24 in this manner, the map information from various sources can be displayed on the rear side.

### Fourth Embodiment

In each of the above embodiments, the case where the collision reduction brake was activated has been described as an example of the driving assistance. However, each of the above embodiments is also applicable to other types of driving assistance. In the present embodiment, a description will be given with regard to a display example in a case where the parking assistance was activated as the driving assistance, but did not complete.

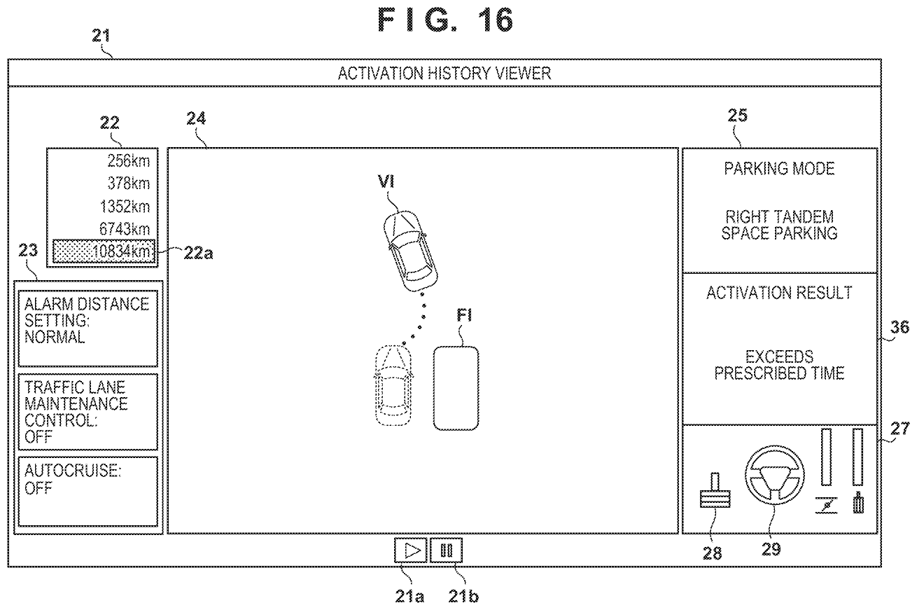

FIG. 16 illustrates a display example of the display device 5, and illustrates an example of the behavior information 21 in the present embodiment. In the assistance content display area 25, “parking mode” indicating the parking assistance is displayed as information representing the type of driving assistance that has been activated. In particular, “right tandem space parking” indicating that tandem parking is automatically conducted is displayed.

The behavior information 21 includes an activation result display area 36, and displays a reason why the parking assistance did not complete (a cancellation reason). In the illustrated example, the parking that did not complete within a prescribed time is displayed with its reason.

In the reproduced video display area 24, an image FI of a parking frame assumed at the time of the parking assistance is displayed. The reproduction of the video is started by an operation of the reproduction button 21a. In the illustrated example, it is assumed that a video in which the vehicle image VI moves from a location represented by a broken line to a location represented by a solid line is reproduced. The location represented by the solid line is the location where the parking assistance of the vehicle V was cancelled.

Also in the present embodiment, by presenting the behavior information 21 to the owner of the vehicle V who has requested the explanation, it becomes possible to explain the activation situation of the driving assistance system in a more easily understandable manner, and it becomes possible to clear up misunderstanding of malfunction and failure. In particular, by displaying the video in which the behavior of the vehicle V is reproduced in the reproduced video display area 24, it becomes possible to explain in a visually understandable manner. By also displaying the image FI of the parking frame, it becomes possible to make the owner deeply understand the system, while a service person and the owner are checking the situation during the activation.

### Fifth Embodiment

In the first to fourth embodiments, the behavior information 21 includes the reproduced video display area 24, and the reproduced video including the behavior of the vehicle V is displayed. However, instead of this, any other display form, such as displaying a chronological change in each parameter included in the motion history information, in a bar graph, a line graph, or the like may be applicable.

### Summary of Embodiments

The above embodiments disclose at least an information processing apparatus, a program, and a storage medium in the following.

1. The information processing apparatus (1) of the embodiment includes an acquisition unit (2, S1) configured to acquire, from a vehicle (V), activation history information of driving assistance by a driving assistance system (7) on the vehicle and motion history information of the vehicle; and a display control unit (2, S3) configured to cause a display device (5) to display behavior information (21) indicating chronological behavior of the vehicle in a situation in which the driving assistance was activated, based on the activation history information and the motion history information acquired by the acquisition unit.

According to this embodiment, it is possible to provide a tool capable of explaining an activation situation of the driving assistance system in a more easily understandable manner.

2. In the embodiment, the behavior information includes a video that reproduces the behavior of the vehicle.

According to this embodiment, it is possible to provide a visually recognizable explanation.

3. In the embodiment, the video (24) shows the behavior of the vehicle in a bird's eye view.

According to this embodiment, it is possible to provide a visually recognizable explanation.

4. In the embodiment, the display control unit causes the display device to display the video superimposed on map information (FIGS. 12 and 15).

According to this embodiment, it is possible to explain the activation situation of the driving assistance system in a more easily understandable manner while referring to the travel environment of the road.

5. In the embodiment, the acquisition unit acquires operation history information of a driver of the vehicle, and the display control unit displays, together with the video, information (27) indicating a driving operation by the driver in a situation in which the driving assistance was activated, based on the operation history information.

According to this embodiment, it is possible to explain the relationship between the activation situation of the driving assistance system and the driving operation performed by the driver in a more easily understandable manner.

6. In the embodiment, the motion history information includes a vehicle speed and a steering angle of the vehicle, and the operation history information includes information regarding an accelerator operation, a brake operation, and a steering operation by the driver.

According to this embodiment, it is possible to reproduce the behavior of the vehicle more accurately, and it is possible to explain the relationship with the driving operation performed by the driver in a more easily understandable manner.

7. In the embodiment, the display control unit displays, together with the video, information (25) indicating a type of the driving assistance at an activation timing of the driving assistance (FIGS. 6 and 7).

According to this embodiment, it is possible to enhance understanding of an activation trigger of the driving assistance system.

8. The information processing apparatus of the embodiment, further includes a reception unit (32) configured to receive a selection of an item indicating a travel environment of a road on which the vehicle was traveling at a time of activation of the driving assistance, wherein the display control unit displays, together with the video, the item the selection received by the reception unit (FIG. 10).

According to this embodiment, it is possible to explain the activation situation of the driving assistance system in a more easily understandable manner while referring to the travel environment of the road.

9. In the embodiment, the driving assistance includes automatic braking (FIG. 2A), automatic steering (FIG. 2B), and/or a notification (15) to a driver.

According to this embodiment, it is possible to explain the activation situation of the driving assistance system about which the driver may feel strange, in a more easily understandable manner.

10. In the embodiment, the driving assistance includes parking assistance of the vehicle (FIG. 2C), and the video at a time of the parking assistance includes an image (FI) indicating a parking frame (FIG. 16).

According to this embodiment, it is possible to explain the activation situation of the parking assistance in a more easily understandable manner.

11. The program (FIG. 3) of the embodiment causes a computer (2) to function as: an acquisition unit (2, S1) configured to acquire, from a vehicle (V), activation history information of driving assistance by a driving assistance system (7) on the vehicle and motion history information of the vehicle; and a display control unit (2, S3) configured to cause a display device (5) to display behavior information (21) indicating chronological behavior of the vehicle in a situation in which the driving assistance was activated, based on the activation history information and the motion history information acquired by the acquisition unit.

According to this embodiment, it is possible to provide a tool capable of explaining an activation situation of the driving assistance system in a more easily understandable manner.

12. The non-transitory computer-readable storage medium of the embodiment stores a program that causes a computer (2) to function as: an acquisition unit (2, S1) configured to acquire, from a vehicle (V), activation history information of driving assistance by a driving assistance system (7) on the vehicle and motion history information of the vehicle; and a display control unit (2, S3) configured to cause a display device (5) to display behavior information (21) indicating chronological behavior of the vehicle in a situation in which the driving assistance was activated, based on the activation history information and the motion history information acquired by the acquisition unit.

According to this embodiment, it is possible to provide a tool capable of explaining an activation situation of the driving assistance system in a more easily understandable manner.

The invention is not limited to the foregoing embodiments, and various variations/changes are possible within the spirit of the invention.

What is claimed is:

1. An information processing apparatus comprising:
an acquisition unit configured to acquire, from a vehicle, activation history information of driving assistance by a driving assistance system on the vehicle and motion history information of the vehicle; and
a display control unit configured to cause a display device to display behavior information indicating chronological behavior of the vehicle in a situation in which the driving assistance was activated, based on the activation history information and the motion history information acquired by the acquisition unit.

2. The information processing apparatus according to claim 1, wherein
the behavior information includes a video that reproduces the behavior of the vehicle.

3. The information processing apparatus according to claim 2, wherein
the video shows the behavior of the vehicle in a bird's eye view.

4. The information processing apparatus according to claim 3, wherein
the display control unit causes the display device to display the video superimposed on map information.

5. The information processing apparatus according to claim 2, wherein
the acquisition unit acquires operation history information of a driver of the vehicle, and
the display control unit displays, together with the video, information indicating a driving operation by the driver in a situation in which the driving assistance was activated, based on the operation history information.

6. The information processing apparatus according to claim 5, wherein
the motion history information includes a vehicle speed and a steering angle of the vehicle, and
the operation history information includes information regarding an accelerator operation, a brake operation, and a steering operation by the driver.

7. The information processing apparatus according to claim 2, wherein
the display control unit displays, together with the video, information indicating a type of the driving assistance at an activation timing of the driving assistance.

8. The information processing apparatus according to claim 2, further comprising
a reception unit configured to receive a selection of an item indicating a travel environment of a road on which the vehicle was traveling at a time of activation of the driving assistance, wherein
the display control unit displays, together with the video, the item the selection received by the reception unit.

9. The information processing apparatus according to claim 1, wherein
the driving assistance includes automatic braking, automatic steering, and/or a notification to a driver.

10. The information processing apparatus according to claim 2, wherein
the driving assistance includes parking assistance of the vehicle, and
the video at a time of the parking assistance includes an image indicating a parking frame.

11. A non-transitory computer-readable storage medium for storing a program that causes a computer to function as:
an acquisition unit configured to acquire, from a vehicle, activation history information of driving assistance by a driving assistance system on the vehicle and motion history information of the vehicle; and
a display control unit configured to cause a display device to display behavior information indicating chronological behavior of the vehicle in a situation in which the driving assistance was activated, based on the activation history information and the motion history information acquired by the acquisition unit.
